(19) United States
(12) Patent Application Publication
(10) Pub. No.: US 2019/0028561 A1
(43) Pub. Date: Jan. 24, 2019

(54) Method and System of Forming Local and/or Hierarchical Cloud Networks

(71) Applicant: Nucleos, Inc., Santa Cruz, CA (US)

(72) Inventor: Noah Freedman, Santa Cruz, CA (US)

(21) Appl. No.: 16/044,403

(22) Filed: Jul. 24, 2018

Related U.S. Application Data
(60) Provisional application No. 62/536,281, filed on Jul. 24, 2017.

(51) Int. Cl. H04L 29/08; H04L 29/06; H04L 12/26; G06F 9/50

(52) U.S. Cl. CPC H04L 67/2814; H04L 67/322; H04L 67/1008; G06F 9/5005; H04L 63/10; H04L 43/0876; H04L 67/101

(57) ABSTRACT

In accordance with embodiments of the invention there is provided a method comprising: providing a first server communicatively coupled to the Internet and in communication with the Internet and communicatively coupled to a local network other than via the internet; providing a first workstation in communication with the first server via the local network and other than via the Internet; transmitting via the local network and other than via the Internet from the first workstation to the first server a request for access to a cloud service; when communication via the Internet is available, providing from the first server via the Internet a request for the cloud service; and when the Internet is other than available, providing the cloud service by the first server via the local network.

### CROSS-REFERENCES TO RELATED APPLICATIONS

This application claims the benefit of U.S. Provisional Patent Application No. 62/536,281, filed Jul. 24, 2017, and incorporates the disclosure of the application by reference.

### BACKGROUND

When the Internet became popular, many services and data sets were published to the Internet and made widely available. Thus, World Wide Web (Web) sites such as www.wikipedia.com that provide data on a large range of subjects became available to anyone with an Internet connection. At the time, each Web site was hosted on a physical server or set of servers and, as such, was within the physical control of a provider. Over time, companies such as Akamai® and CloudFlare® proliferated the concept that distributed data was better to balance load and traffic and a natural extension of this was cloud computing.

Cloud computing is a kind of Internet-based computing that provides shared processing resources and data to computers and other devices on demand. It is a model for enabling ubiquitous, on-demand access to a shared pool of configurable computing resources such as networks, servers, storage, applications and services, which can be rapidly provisioned and released with minimal management effort. Cloud computing and storage solutions provide users and enterprises with various capabilities to store and process their data in third-party data centers. It relies on sharing of resources to achieve coherence and economy of scale, similar to a utility and accessible over a network.

In cloud computing, it is known what will happen, but where and on which system is not predetermined. Thus, data stored in the cloud may be stored anywhere and data processed in the cloud may be processed anywhere. That said, what is common to all cloud applications is their requirement for Internet conductivity.

Some cloud providers only work through an Internet portal, a Web browser, while others have custom applications. These applications only function in the presence of an Internet connection and sometimes only in the presence of a good Internet connection. For example, Netflix® has an application that can only allow you to watch movies when you are connected to the Internet. Similarly, Facebook® has an application that only lets you browse your Facebook® data when connected to the Internet.

It would be advantageous to support cloud-based functionality even when there is a poor Internet access or no Internet access at all.

### SUMMARY OF THE TECHNOLOGY

In accordance with embodiments of the invention there is provided a method comprising: providing a first server communicatively coupled to the Internet and in communication with the Internet and communicatively coupled to a local network other than via the internet; providing a first workstation in communication with the first server via the local network and other than via the Internet; transmitting via the local network and other than via the Internet from the first workstation to the first server a request for access to a cloud service; when communication via the Internet is available, providing from the first server via the Internet a request for the cloud service; and when the Internet is other than available, providing the cloud service by the first server via the local network.

In some embodiments the cloud service provided by the first server is similar to the cloud service provided by the cloud service.

In some embodiments the cloud service provided by the first server is identical to the cloud service provided by the cloud service on a known day and time.

In some embodiments the cloud service provided by the first server is a limited version of the cloud service provided by the cloud service.

In some embodiments the Internet is other than available when a quality of Internet connectivity is below a first threshold.

In some embodiments the first threshold is provided by a provider of the cloud service.

In some embodiments the first threshold is based on a parameter that is modifiable by an administrator of the server.

In some embodiments the first threshold is dynamically determined based on a network utilization and a quality of locally stored data from the cloud service.

In some embodiments the first threshold is dynamically determined based on a priority of a user from whom the request originates.

In some embodiments responses provided from a local server are provided to the workstation as if originating from the cloud service.

In some embodiments responses provided from a local server are provided to the workstation with an indication that they are being serviced by a local server.

In accordance with another embodiment of the invention there is provided a method comprising: providing a first server communicatively coupled to the Internet and in communication with the internet and communicatively coupled to a local network other than via the Internet, the first server including software thereon from a first cloud service provider and for providing a first cloud service when Internet connectivity quality is below a first threshold; providing a first workstation in communication with the first server via the local network and other than via the Internet; transmitting via the local network and other than via the Internet from the first workstation to the first server a request for access to the first cloud service; when communication via the Internet is quality is above a first threshold, providing from the first server via the Internet a request for the first cloud service to the first cloud service provider; and when the quality is below a first threshold, providing the first cloud service by the software from the first cloud service provider installed within the first server and executed thereon via the local network.

In accordance with another embodiment of the invention there is provided a method comprising: providing a first server communicatively coupled to the Internet and in communication with the Internet and communicatively coupled to a local network other than via the Internet, the first server including first software thereon from a first cloud service provider and for providing a first cloud service when Internet connectivity quality is below a first threshold; providing a first workstation in communication with the first server via the local network and other than via the Internet; rerouting a request to the first software addressed, the request rerouted to the first cloud service provider for access to the first cloud service from the first workstation to the first server via the local network and other than via the Internet; and the first software responding to the request with at least some data retrieved from a local data store and at least some data retrieved from the cloud service.

In accordance with another embodiment of the invention there is provided a method comprising: providing a first server communicatively coupled to the Internet and in communication with the Internet and communicatively coupled to a local network other than via the Internet; providing a first workstation in communication with the first server via the local network and other than via the Internet; determining a quality of network connectivity between a first cloud service and the local network; when Internet communication quality is above a first threshold, providing from the first workstation via the Internet a request for the first cloud service to the first cloud service provider; and when the Internet communication quality is below the first threshold, providing from the first workstation a request to a local server for providing the first cloud service by the local server and via the local network.

In some embodiments the local server reroutes a cloud request.

In some embodiments the local server resolves a request address to a local server when the Internet communication quality is below the first threshold.

In some embodiments resolving the request address comprises resolving a DNS request, the DNS request resolved differently depending on a quality of Internet connectivity.

In accordance with another embodiment of the invention there is provided a method comprising: providing a request to a first system for accessing data via the Internet; determining if the data is accessible via a local cloud server; and when the data is accessible via a local server, routing the request to the local server other than via the Internet.

In accordance with another embodiment of the invention there is provided a method comprising: requesting of a URL a response from the URL, the URL for being accessed via the internet; determining within a network accessible other than via the Internet whether to access the URL via the Internet or to access the URL from a local cloud server, the local cloud server servicing requests of at least one URL and other than at the accurate DNS address for said at least one URL; and when it is determined to service the request locally, serving data in response to the request and responsive thereto from the local cloud server, wherein at least some requests are serviced locally and at least some requests are serviced from the accurate DNS address for the URL.

In accordance with another embodiment of the invention there is provided a computer system comprising: a processor, memory and a communication transducer, the computer system for assessing network performance of an external network communicatively coupled with the communication transducer; and for when the network performance is below a predetermined threshold, redirecting a first network request to a server within a local network for being responded to, the server for providing similar functions to the first network request.

In some embodiments redirecting is to the computer system.

In some embodiments redirecting is to another server within the local network.

In accordance with another embodiment of the invention there is provided a computer system comprising: a processor, memory and a communication transducer, the computer system for assessing network performance of an external network communicatively coupled with the communication transducer; for allowing some network traffic to be routed via the network and for re-routing a first network request destined for a network location outside the local network server within the network to a server on a network local to the computer system, the server for responding to, the server for providing similar functions to the first network request.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified network diagram of a wide area network supporting a variety of functions;

FIG. 2 is a simplified network diagram of the wide area network similar to that of FIG. 1 with some of the network connectivity restricted;

FIG. 3 is a simplified network diagram of a wide area network similar to that of FIG. 1 wherein a first local cloud server acts to source services from the edge;

FIG. 4 is a simplified network diagram of a wide area network similar to that of FIG. 1 wherein a first server acts to source some services from the edge while other services are sourced from the Internet;

FIG. 5 is a simplified network diagram of a wide area network similar to that of FIG. 1 wherein a first server acts to source some services from the edge and automatically updates those services when Internet connectivity is available;

FIG. 6 is a simplified network diagram of a wide area network similar to that of FIG. 1 wherein a first server acts to source some services from the edge while other services are sourced from the Internet, the services sourced locally determined based on network availability and connectivity quality;

FIG. 7 is a simplified network diagram of a wide area network similar to that of FIG. 1 wherein a first server acts to source a same service from both the edge and the Internet based on data availability, other factors, or both;

FIG. 8 is a simplified network diagram wherein some connectivity is malfunctioning or absent and wherein the first local cloud server provides some services and data that is unavailable due to the absence or malfunctioning of connectivity;

FIG. 9 is a simplified flow diagram for server operation to support selective URL interception and rerouting;

FIG. 10 is a simplified flow diagram for a first local cloud server that manages connectivity to support varied levels of connectivity;

FIG. 11 is a simplified flow diagram of a synchronization mechanism for data on the first local cloud server;

FIG. 12 is a simplified flow diagram for a method of updating locally stored data for a service, in the form of Facebook®;

FIG. 13 is a simplified flow diagram of a method of setting up a first local cloud server;

FIG. 14 is a simplified flow diagram of an automated method of setting up a first local cloud server;

FIG. 15 is a simplified flow diagram of a method of supporting cloud storage in accordance with the first local cloud server architecture; and

FIG. 16 is a simplified flow diagram of a method of supporting video streaming of popular clips relying on a first local cloud server.

### DETAILED DESCRIPTION OF EMBODIMENTS

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

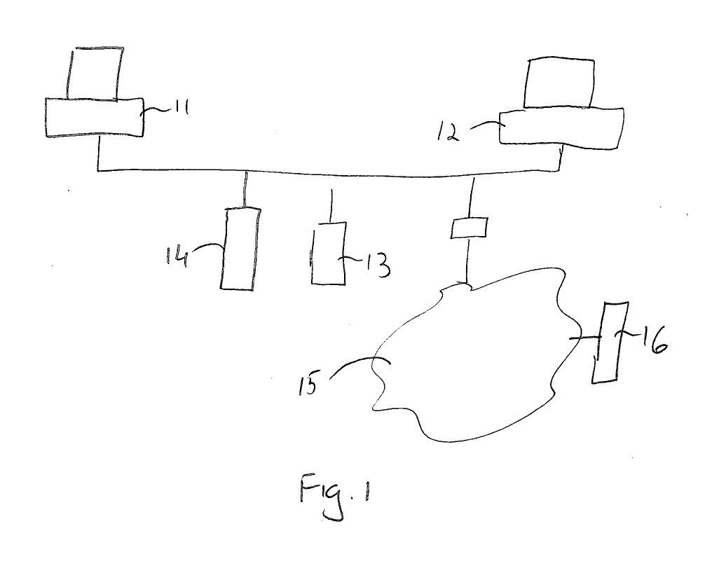

Referring to FIG. 1, shown is a wide area network supporting a variety of functions. Two computers 11 and 12 are shown engaged in peer-to-peer communication. Meanwhile computer 11 is also retrieving data from server 13. Server 14 offers a database for users of computer 11 and computer 12 to access. Cloud 15 includes numerous physical computer devices (not shown) and supports processing and data storage/retrieval without any specified hardware location. Instead, the processing and data storage is performed in a known fashion, but in an unknown hardware device. Finally, as shown, the wide area network connects to a plurality of services at 16 in the form of shopping, ordering, etc. A user of computer 11 can shop at server 16, watch films streamed from the cloud 15, access web sites from server 13, or communicate directly with other computers. This environment is rich and diverse.

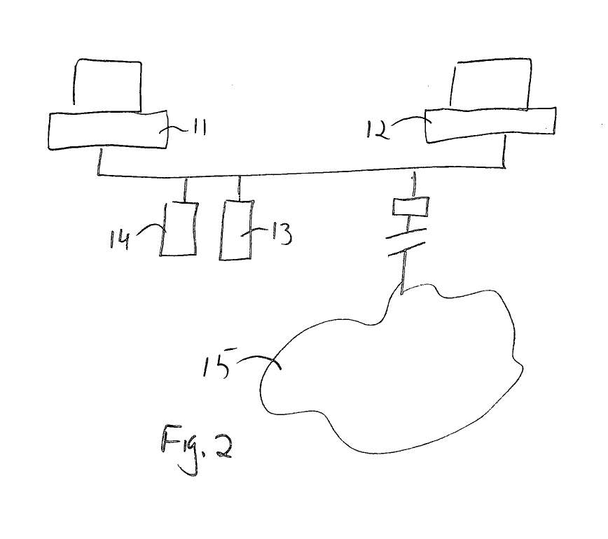

Referring to FIG. 2, shown is the wide area network of FIG. 1, with some of the network connectivity restricted. As is evident from the diagram, Computer 11 and computer 12 are able to communicate directly, one with another via the local area network and to access server 13, but the cloud portion of the wide area network is inaccessible, thereby restricting access to many sites and services. For example, a user accessing Netflix is restricted from viewing any films from the cloud, as cloud access is shown to be interrupted in the diagram. If the cloud access is intermittent, then watching streaming video becomes difficult or uncomfortable due to pauses and quality related issues. Further, intermittent access creates challenges for developers who must accommodate frequent and/or long pauses in Internet access.

In order to overcome the problem that not all devices are always connected to the Internet, some sites such as Netflix® allow users to download some content for later viewing. However, this solution is best for users who have excellent connections to the Netflix cloud at a known time—while at home or at the office—and then later might be offline, for example on an airplane. The solution is poorly suited for areas with constant Internet connectivity issues or questionable Internet bandwidth. As is often the case, taking too long or too many interruptions often makes downloading of large files impracticable or impossible. Further, this solution is very poorly suited to real time or database issues such as shopping, banking, or communication cloud services.

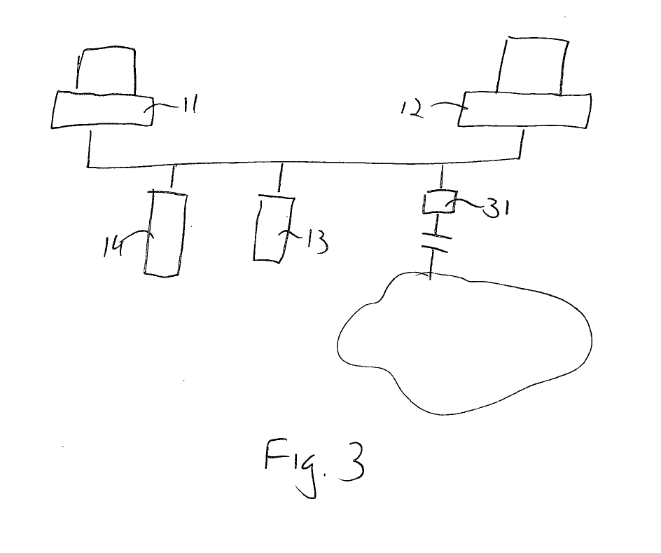

Referring to FIG. 3, shown is a wide area network similar to that of FIG. 1, however a first local cloud server acts to source services from the edge. The first server includes, in execution thereon, a cloud service application that provides cloud services from the local gateway 31 to the local portion of the wide area network. The first server is configured to operate in the absence of Internet connectivity. When the broader wide area network in the form of the Internet is unavailable, either temporarily or permanently, then the local cloud application provides access to local versions of at least a “global” cloud application. For example, the Wikipedia dataset is stored on the first server and the first server acts to resolve Wikipedia URL requests to the first server from which responses to those requests are provided. Thus, the first server acts to provide “Web” content within a local network as if it were in the cloud. In some embodiments, the first server provides “Web” content for several different URLs. In yet another embodiment, different first servers each provide “Web” content from different URLs. Alternatively, the first server supports multiple URLs and works in conjunction with other servers to provide “Web” content.

Unfortunately, because access to the wide area network in the form of the Internet may or may not be available, each of the “Web” datasets is updated manually at intervals, for example by loading contents from a non-volatile storage medium onto the first server to update “Web” content. This allows for a first server loosely synchronized with the web datasets it hosts. Alternatively, a connection to the Internet, for example via a satellite data connection, is established to support an online updating of “web” datasets within the first server. Further alternatively, a connection to the Internet, for example via a satellite data connection, is established to support an online updating of some “web” datasets within the first server while others are manually updated from a non-volatile storage medium.

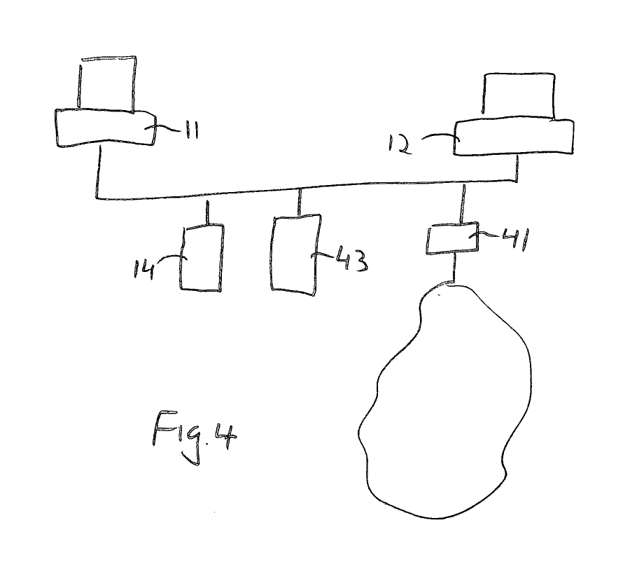

Referring to FIG. 4, shown is a wide area network similar to that of FIG. 1, however a first server 43 acts to source some services from the edge. The first server includes, in execution thereon, a cloud service application that provides cloud services from the local gateway to the local portion of the wide area network. The first server is configured to operate in the presence of Internet connectivity via gateway 41. A local cloud application provides access to local versions of at least a “global” cloud application. For example, the Wikipedia dataset is stored on the first server and the first server acts to resolve Wikipedia URL requests to the first server from which responses to those requests are provided. Thus, the first server acts to provide “Web” content within a local network as if it were in the cloud. In some embodiments, the first server provides “Web” content for several different URLs. In yet another embodiment, different first servers each provide “Web” content from different URLs. Alternatively, the first server supports multiple URLs and works in conjunction with other servers to provide “Web” content.

At the same time as some URLs are locally hosted, other URLs are accessible via the wide area network when the Internet is accessible via gateway 41. Thus, some traffic is rerouted to local first server 43 while the remaining traffic is routed in a typical fashion. The typical fashion includes processes for security, blocking, and filtering of content as desired. Further, a gateway acts to query local servers to determine whether to route traffic to a local server or to a server via the Internet. Alternatively, the gateway has stored thereon a table indicating whether to resolve an address to a local server or to a remote server. Further alternatively, at least one of a local server and the gateway acts upon a set of rules to resolve between situations where data should be retrieved remotely and where data should be served locally. For example, the determination accounts for one or more of the following: the user requesting the data, the type of data, the currency of the locally stored data, the bandwidth available, the quantity of data requested, the likelihood of discrepancies between the local data and the remote data, and so forth.

Unfortunately, because access to the wide area network in the form of the Internet is unreliable, each of the “Web” datasets is updated manually at intervals, for example by loading contents from a non-volatile storage medium onto the first server to update “Web” content. This allows for a first server loosely synchronized with the web datasets it hosts. Alternatively, when a connection to the Internet exists and sufficient excess bandwidth is available, the datasets are updated from a source server accessible via the Internet. In another embodiment a separate Internet connection is established, for example via a satellite data connection, to support an online updating of “web” datasets within the first server. Further alternatively, a connection to the Internet, for example via a satellite data connection, is established to support an online updating of some “web” datasets within the first server while others are manually updated from a non-volatile storage medium.

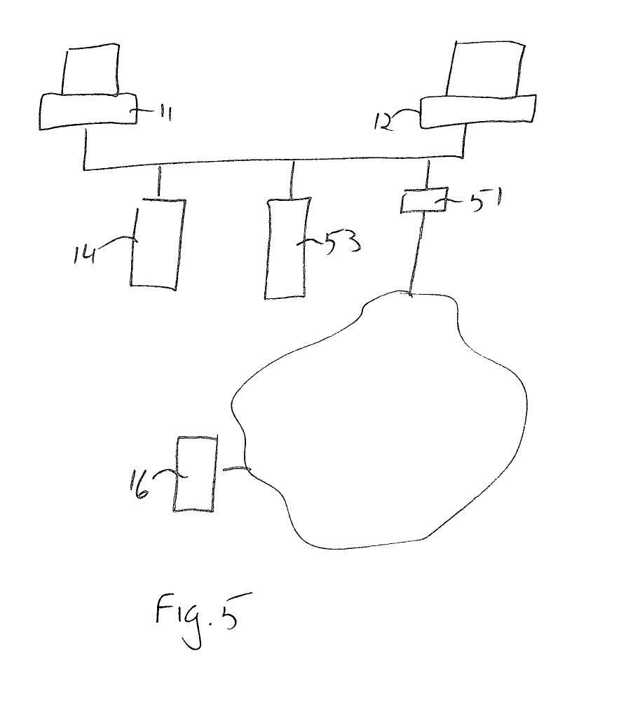

Referring to FIG. 5, shown is a wide area network similar to that of FIG. 1, however a first server 53 acts to source some services from the edge. The first server 53 includes, in execution thereon, a cloud service application that provides cloud services from the local gateway to the local portion of the wide area network. The first server is configured to operate in the presence of Internet connectivity via gateway 51. Optionally, the first server 53 and gateway 51 are a same device. A local cloud application provides access to local versions of at least a “global” cloud application. For example, the Wikipedia dataset is stored on the first server and the first server acts to resolve Wikipedia URL requests to the first server from which responses to those requests are provided. Thus, the first server acts to provide “Web” content within a local network as if it were in the cloud. In some embodiments, the first server provides “Web” content for several different URLs. In yet another embodiment, different first servers each provide “Web” content from different URLs. Alternatively, the first server supports multiple URLs and works in conjunction with other servers to provide “Web” content.

At the same time as some URLs are locally hosted, other URLs are accessible via the wide area network when the Internet is accessible. Thus, some traffic is rerouted to a local first server while the remaining traffic is routed in a typical fashion. The typical fashion includes processes for security, blocking, and filtering of content as desired.

Unfortunately, because access to the wide area network in the form of the Internet is unreliable, each of the “Web” datasets is updated automatically at intervals, when a connection to the Internet exists and sufficient excess bandwidth is available. In another embodiment some data is automatically updated and some requires manual updating. In some embodiments, the user chooses when to undergo major content or app updates, and minor updates happen either automatically—whenever a network connection is present, or when a user choses. When duplication exists within a same local network, updates are optionally sourced from other local servers within the local area network or within accessible networks that are more reliably communicatively coupled to the local network.

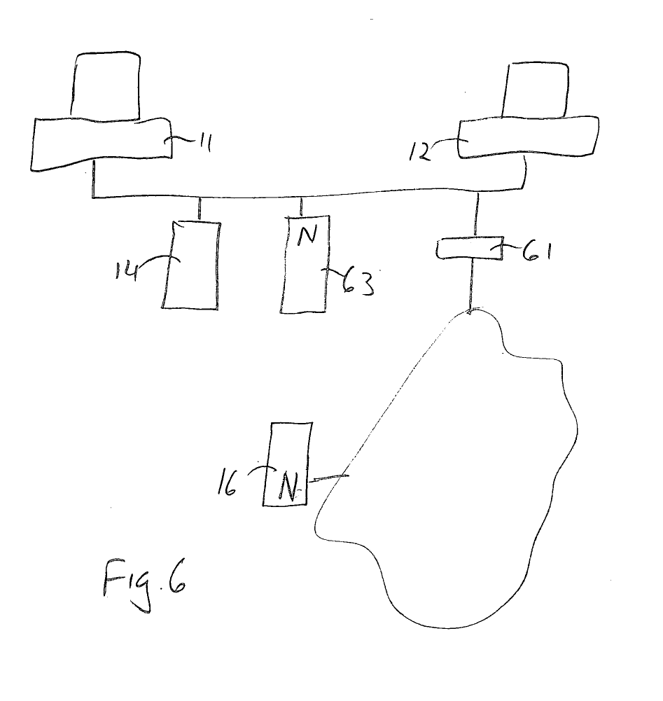

Referring to FIG. 6, shown is a wide area network similar to that of FIG. 1, however a first server 63 acts to source some services from the edge. The first server 63 includes, in execution thereon, a cloud service application that provides cloud services from the local gateway to the local portion of the wide area network when Internet connectivity via gateway 61 is below a predetermined level. In some embodiments, first server 63 and gateway 61 are a same physical device. In some embodiments, the predetermined level of Internet connectivity is configurable by an administrator and optionally is based on connectivity reliability, bandwidth, and usage. When the Internet is available, the first server is configured to pass all Internet traffic through to its anticipated destination. As such, a request for a page from Wikipedia's dataset is provided to the Wikipedia URL and the page is retrieved therefrom. When the Internet is unavailable s—an Internet connectivity value is below a predetermined threshold—the first server provides a local cloud application providing access to local versions of at least a “global” cloud application, in the present example Wikipedia's dataset. As such, when the Internet is available, surfing of Internet data and content is supported, but when the Internet is unavailable, local datasets are hosted for some of the Internet accessible sites. In this example, the Wikipedia dataset is stored on the first server and the first server acts to resolve Wikipedia URL requests when the Internet is unavailable and to provide responses to those requests from the first server. Thus, the first server acts to provide “Web” content within a local network as if it were in the cloud. In some embodiments, the first server provides “Web” content for several different URLs. In yet another embodiment, different first servers each provide “Web” content from different URLs. Alternatively, the first server supports multiple URLs and works in conjunction with other servers to provide “Web” content.

At the same time as some URLs are locally hosted, other URLs are only accessible via the wide area network when the Internet is accessible. Thus, some traffic is rerouted to a local first server when the Internet is unavailable while the remaining traffic is routed in a typical fashion, potentially resulting in communication errors.

Unfortunately, because access to the wide area network in the form of the Internet is unreliable and the local datasets are relied upon, each of the “Web” datasets is updated at intervals, for example by loading contents from a non-volatile storage medium onto the first server to update “Web” content. This allows for a first server loosely synchronized with the web datasets it hosts. Alternatively, when a connection to the Internet exists and sufficient excess bandwidth is available, the datasets are updated from a source server accessible via the Internet, either automatically or through manual intervention. In another embodiment a separate Internet connection is established, for example via a satellite data connection, to support an online updating of “web” datasets within the first server. Further alternatively, a connection to the Internet, for example via a satellite data connection, is established to support an online updating of some “web” datasets within the first server while others are manually updated from a non-volatile storage medium.

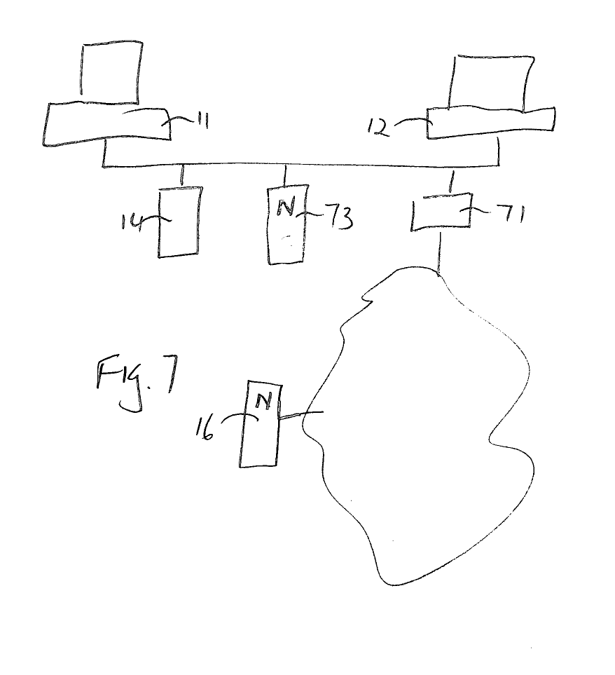

Referring to FIG. 7, shown is a wide area network similar to that of FIG. 1, however a first server 73 acts to source some services from the edge. The first server 73 includes, in execution thereon, a cloud service application that provides cloud services from the local gateway 71 to the local portion of the wide area network. In some embodiments, the local server 73 and the local gateway 71 are a same physical device. When the broader wide area network in the form of the Internet is available, then the local cloud application provides access to the “global” cloud application, either directly or acting as an intermediary. When the Internet is unavailable, the “local” cloud application provides a limited version of the service; for example, a local Netflix® provides access to a small subset of the films available from the “global” cloud application. As is evident, the local gateway has a higher availability than the global cloud application and, as such, those services and data available locally are more reliably and more consistently available. When services are more distributed, data is typically more secure, since it resides locally and therefore somewhat under local control. In contrast, aggregated data presents a higher-value target to would-be attackers of centrally-hosted data centers.

Because the local cloud application has access to local data, inserting it as an intermediary is useful in affecting bandwidth utilization. In the Netflix® example presented above, any film that is stored locally, if provided from the local store thereby reducing the amount of data retrieved from the cloud, reduces the consumers' cloud bandwidth usage and potentially reduces Netflix's® server costs, bandwidth costs, and management and overhead.

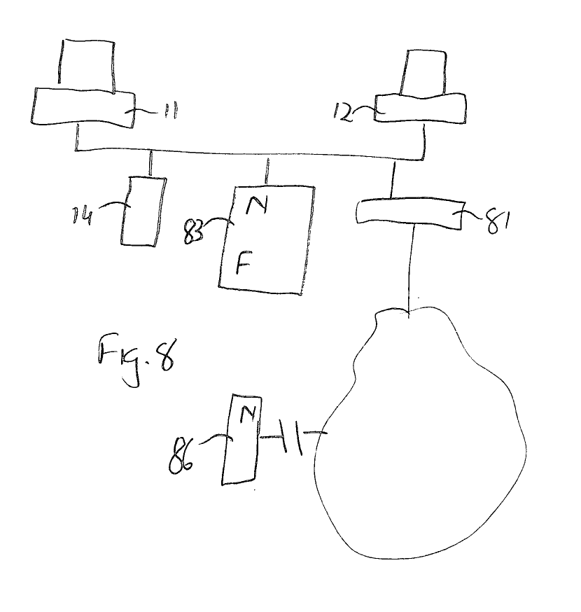

Referring to FIG. 8, shown is a wide area network similar to that of FIG. 3, where some network connectivity is absent. As is evident, the first server 83 mimics some of the inaccessible services from server 86 providing them from gateway 81. In some embodiments, the server 83 and the gateway 81 are a same device. Here as shown (with an N), a limited version of Netflix® is supported, Wikipedia is fully accessible, though each page has a last updated indication, and Facebook® provides local subscribers with a portion of their feeds as bandwidth permits. The Facebook application executing on the first server uses available and unconsumed bandwidth to preload local subscriber feeds reducing the overall instantaneous bandwidth requirements during peak times of use. Because the local subscriber base is somewhat stable, the application is able to support much of the local population without needing 24/7 reliable Internet connectivity. However, the features, advertisements, etc. from Facebook are still supportable and reportable based on user's actual interactions with the cloud application in execution on the first server. Thus, the “global” Facebook® features appear to be supported such as messaging, photo sharing, friend requests, etc. without requiring constant and highly reliable Internet connectivity.

When bandwidth is available and unused, the local Facebook® cloud application accesses the global Facebook® site to retrieve information. Even if the local Facebook® application merely loaded advertisements, clickbait, and some video content, the overall bandwidth requirement during peak usage times is reduced. Of course, reporting on clicks and user interactions with content is optionally performed in a low bandwidth model during use or in a caching model wherein the Facebook® cloud application stores data relating to usage and reports it to the Facebook® global site during off peak times, times of low utilization, or times of cloud availability. In some embodiments, Facebook® as an organization determines the reporting structure and requirements for their cloud application. In other embodiments, reporting is monitored and in yet other embodiments, reporting is in accordance with a set of first server guidelines.

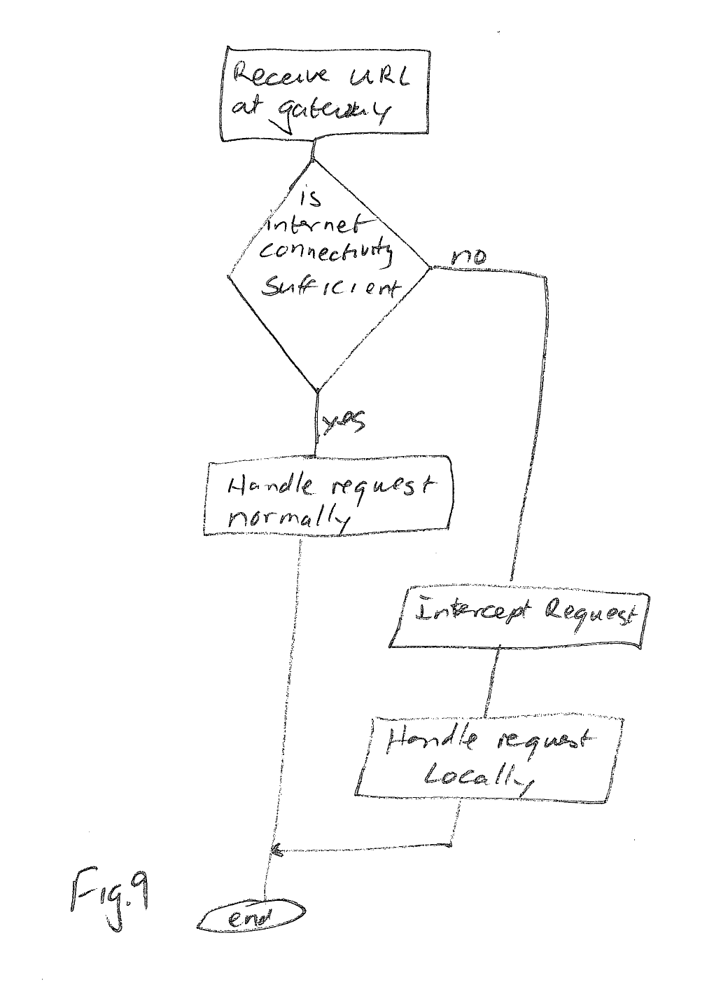

Referring to FIG. 9, a simplified flow diagram for a first local cloud server is shown. The first local cloud server provides a single point for coupling a wide area “local” network with the wide area “global” network in the form of the Internet. The gateway supports a variety of functions just like a typical network node. However, the gateway also supports URL interception where some URLs are intercepted by the gateway and handled directly thereby. Here, a first URL is intercepted by the first local cloud server. The first local cloud server determines a level of Internet connectivity. When connectivity is above a predetermined threshold, the first local cloud server provides pass through connectivity to the intercepted URL. When connectivity is below the predetermined threshold, the first local cloud server provides data in response to requests of the URL, effectively mimicking the URL. For example, when the intercepted URL is Wikipedia, the data stored local to the first local cloud server is provided in response to a Wikipedia request instead of the data stored with the global Wikipedia website. Advantageously, the gateway also supports accepting donations for Wikipedia just like the global Wikipedia web site. However, the payments are received locally and processed when network connectivity is sufficient to do so. Alternatively, they are processed through a separate network, such as a network of a financial institution. Thus, the search and other features of Wikipedia are supported, but provided from the local first local cloud server, as are other features like payment processing. To the end user, the Wikipedia site appears to be available 24/7 regardless of connectivity. In some embodiments, each page retrieved from the first local cloud server storage is labeled with a date that it was downloaded from the global site allowing for verification and updating of locally stored data. In an embodiment, local authentication of payment transactions is performed, relying upon block chain technology to provide local transaction histories used for authorization of transactions.

In some embodiments, the first local cloud server supplies some of those services completely. The first local cloud server maintains an appearance of network reliability and connectivity even when none is present. For any content that is slow changing relative to Internet reliability issues, such as Wikipedia, such an approach will most often appear to provide seamless and unerring Internet connectivity. Of course, for more rapidly changing information such as stock prices, the approach will have notable drawbacks.

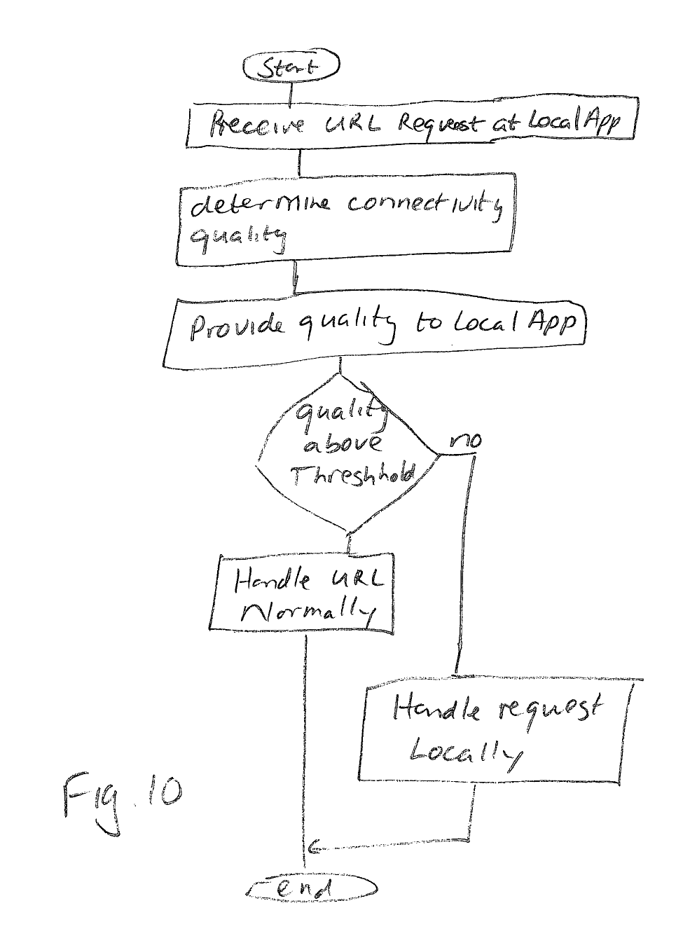

Referring to FIG. 10, a simplified flow diagram is shown for a first local cloud server that manages connectivity to support varied levels of connectivity. The first local cloud server includes a first process for managing general Internet connectivity, a second process for managing local wide area network connectivity, an interception process for intercepting predetermined URLs, and a plurality of processes for providing services to each of the plurality of predetermined URLs. Here, the first process provides an indicator of network reliability to each of the plurality of processes. The indicator is one of available and unavailable. Alternatively, the indicator provides a value reflective of present bandwidth. Further alternatively the indicator provides a value relating to reliability of the network for supporting certain types of requests; for example, high bandwidth is 2% reliable, very low bandwidth is 70% reliable and downloading large files is 5% reliable whereas downloading small files is 90% reliable. This allows each of the plurality of applications to manage intermittent connectivity differently than consistent low bandwidth connectivity. Further, it allows the plurality of applications to manage downloading and streaming issues based on the value indicator. In some embodiments, different network traffic is prioritized based on configurable flexible access control lists for users, applications, and processes. In some embodiments, different network traffic is prioritized based on network communication conditions and usage.

Some cloud-based services perform very well with intermittent connectivity issues so long as sufficient average bandwidth is supported; other services do not. Some services operate very well in low bandwidth settings; other services are difficult or near impossible to use in low bandwidth environments. Of course, high and low bandwidth are relative terms that are different for different applications; video streaming requires a higher average bandwidth than text messaging and, therefore, high bandwidth for video streaming services is different from high bandwidth for text messaging services. Augmented reality and virtual reality applications will use even higher bandwidth.

Alternatively, the first local cloud server selects whether to intercept a URL request based on the value indicator. Thus, the first local cloud server controls what is acceptable bandwidth. Of course, there are significant advantages to making those decisions at the server software as it allows for overall load analysis and supports background download and caching operations and balancing between multiple applications, multiple users, multiple servers and multiple URLs. Conversely, making decisions at the application is often advantageous because the application is best suited to determining its own requirements. Balancing the applications knowledge of its own requirements with the overall system requirements and availability of communications is manageable via an API that allocates to applications resources based on their decisions and a set of management preferences, server system preferences, network preferences, and other considerations.

In an alternative embodiment, the first local cloud server selects whether to intercept a URL request based on the value indicator and data provided by each of the plurality of processes. Thus, each of the plurality of processes indicates, for example, what is acceptable bandwidth and reliability. The server software then makes decisions allowing for overall load analysis and support, background download and caching operations and balancing between multiple applications—each with its own requirements—and multiple users—each with their own usage patterns—and multiple URLs.

In some embodiments, when an application is capable of serving a request without Internet communication, it informs the server of this such that the server can work that into its decision making process. For example, if a Netflix® user requests a film that is already stored on the first local cloud server, then passing the request through to the “global” Netflix® server is unnecessary and the bandwidth and reliability issues need not be evaluated. As more services support self contained operations within the first local cloud server, the first local cloud server communications reliability and bandwidth allocation increases for other URLs.

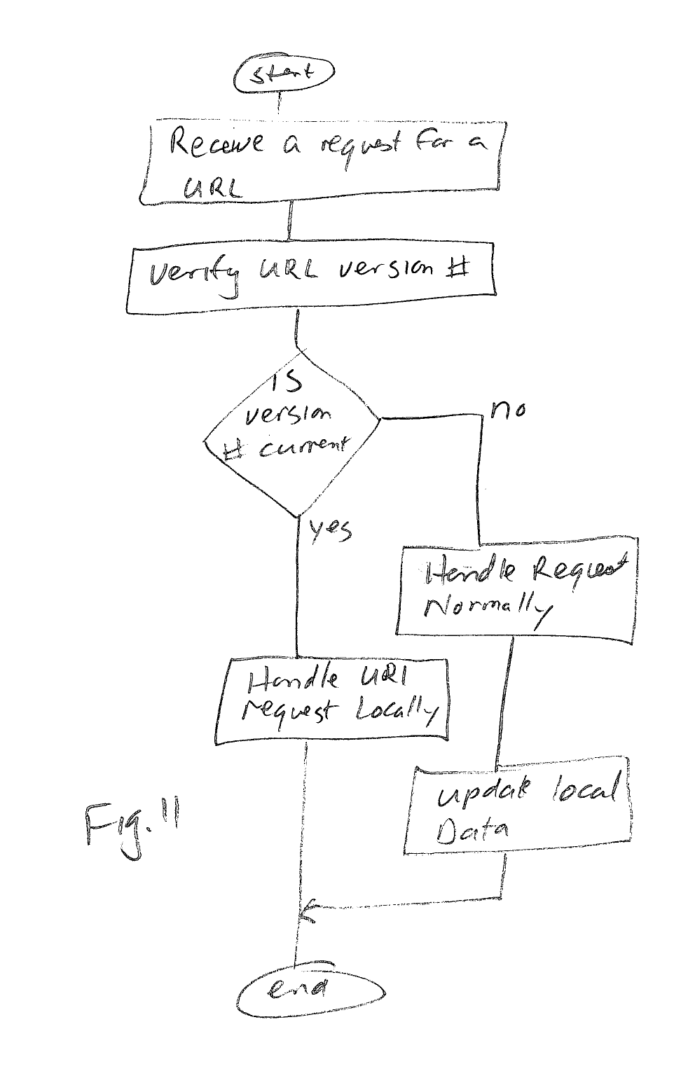

Referring to FIG. 11, shown is a simplified flow diagram of a synchronization mechanism for data on the first local cloud server. Here, semi-static data is stored on the first local cloud server, in the form of the Wikipedia dataset. For each entry, a current version number is copied from the global Wikipedia dataset and stored in association with the copy on the first local cloud server. When a datum is served to an end user, the first local cloud server application verifies the version number against the global Wikipedia dataset and determines if the datum is up to date. When the datum is not up to date, it is updated, bandwidth permitting. Alternatively, when bandwidth other than permits, the previous version is delivered to the end user. Of course when the datum is up to date, the datum on the first local cloud server is delivered to the end user.

Thus, for news, and other time critical but slowly changing data, a first local cloud server manages data updates and synchronization as a background task except when bandwidth is available and a request returns stale data. This allows for updating of semi-static data at intervals during low bandwidth utilization or when bandwidth remains available. When data is slow changing but highly sought after, such as local news, the method limits the bandwidth consumed while supporting same or approximately same level of service.

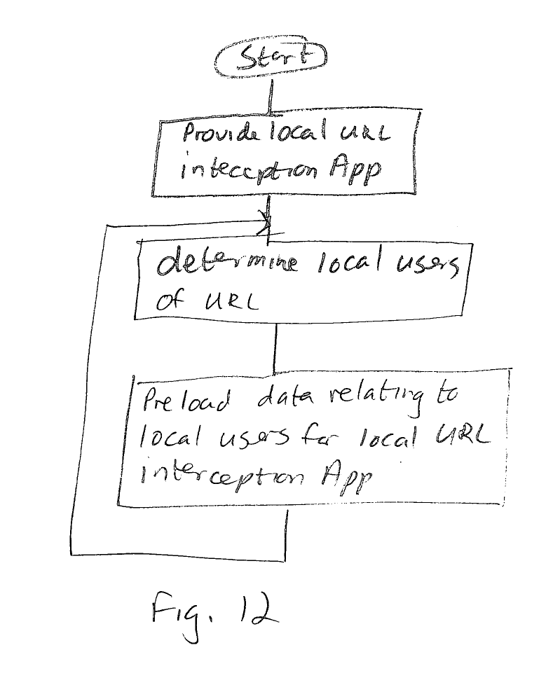

Referring to FIG. 12, shown is a simplified flow diagram for a method of updating locally stored data for a service, in the form of Facebook®. Here, each user that accesses Facebook is identified and stored in a table. The first local cloud server uses the table to download Facebook® feeds for each of the users that accessed Facebook® via the first local cloud server during the previous days when bandwidth is available. Thus, when a user returns to look at Facebook®, their recent data is stored on the first local cloud server accessible to the Facebook® application and allowing for them to review their Facebook® feed—to surf the Internet—without having high quality Internet communication or any Internet communication when reviewing. If Internet communication exists, then the user can access their feed, but the first local cloud server need only download from the last feed data to the present point in time, as the older data is already stored on the server.

The PortableCloud local cloud servers can also use machine learning models to predict data request models for each individual user or statistical groups of users, and pre-fetch and cache a range of content they are estimated to request before it is used. Of course, the Facebook® application or the local cloud server optionally secures data in a manner appropriate for retaining privacy and confidentiality of data cached locally, when desired.

As noted before, the feed still supports advertising, metric calculations, clickbait, video, etc. even when in execution in low-bandwidth environments. Further, features such as poking, posting, sharing, messaging, and friending are also supported via the local service which caches many of these for provision to the global service when bandwidth becomes available.

In an alternative embodiment, the first local cloud server operates with other interconnected first local cloud servers in the absence of a communication link with a “global” service to provide the service locally, but better. For example, Netflix® local applications supports 100 films instead of 60 when three first local cloud servers remain in communication across three disparate communities. This, for example, results when a community's first local cloud server is then coupled to three intra community first local cloud servers—local coffee shops—allowing the service level and reliability of the four-server wide area network to be high even though the reliability of the Internet connection is substantially lower.

In such a case, a user who visits a first coffee shop every day for three months has their Facebook® feed stored on the first coffee shop's first local cloud server. If that user visits a second coffee shop, the first local cloud server of that second coffee shop retrieves the user's Facebook® feed from the first local cloud server of the first coffee shop in the absence of Internet connectivity. Optionally, the group of four first local cloud servers is set up as a single intercepting server—the four servers use a single DNS interceptor—so that the user's Facebook® feed is retrieved from the first coffee shop's first local cloud server regardless of from where within the community the user connects to the network.

Alternatively, such an architecture allows for duplication of resources to improve reliability and fault tolerance.

Security and encryption of data across the servers limits access to another's data at rest stored by an application if they obtained access to one of the local cloud servers, when implemented. Thus, data that is stored for later communication via the network, for example payment information, is secured against tampering and unauthorized access. In this way, private communications remain private.

In another embodiment, the servers cooperate to each perform different functions such that one server intercepts Facebook® requests while another first local cloud server serves Wikipedia data to the local community.

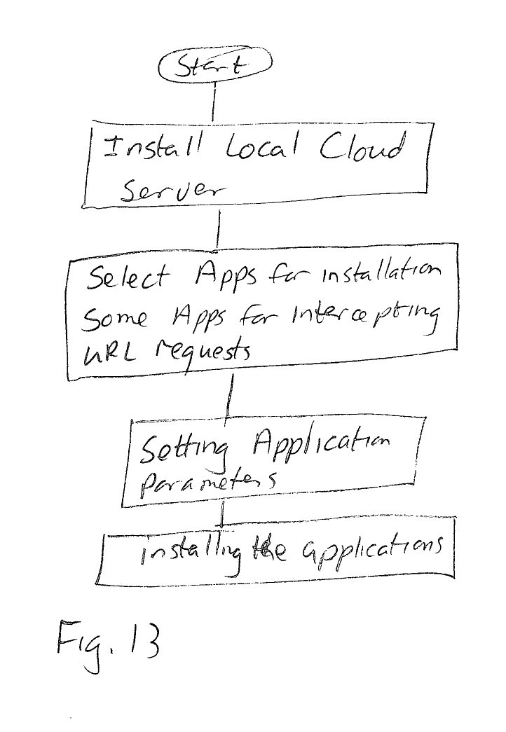

Referring to FIG. 13, shown is a simplified flow diagram of a method of setting up a first local cloud server. A plurality of applications is available for execution within the local cloud. Some applications are generic or open source, while others are privately developed, tightly controlled and only available from the global service provider for the URL. An administrator selects the applications to install on the first local cloud server and installs those applications. In some embodiments, applications are each provided a priority for supporting users in difficult climates, for example, a first local cloud server at a university may provide priority to Wikipedia and academic sources over Netflix® and Facebook® even though all are supported in an ideal situation. Of course, priorities will differ where a coffee shop may have one set of priorities, a workplace another, and a hotel yet another.

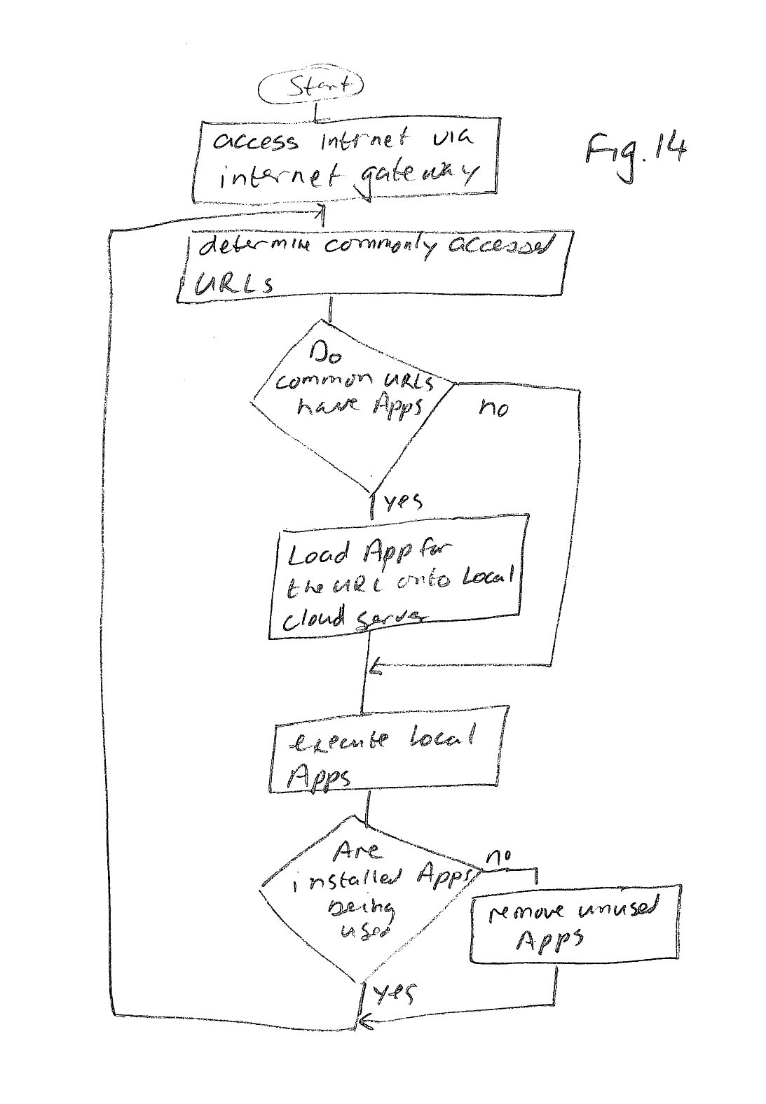

Referring to FIG. 14, shown is a simplified flow diagram of an automated method of setting up a first local cloud server. A first local cloud server is set up and in execution. As users access URL's repeatedly, the server learns the patterns of utilization and seeks applications from sites that are visited often via the first local cloud server. Over time, the first local cloud server automatically installs applications when available and those applications begin to manage access to an associated global service. As applications are less used, the first local cloud server optionally removes some applications and installs others as the automated process determines. This allows a first local cloud server to remain relevant in the face of changes to user behavior and popular destinations within the World Wide Web. Alternatively, the first server maintains a log for use in manual installation and removal of applications.

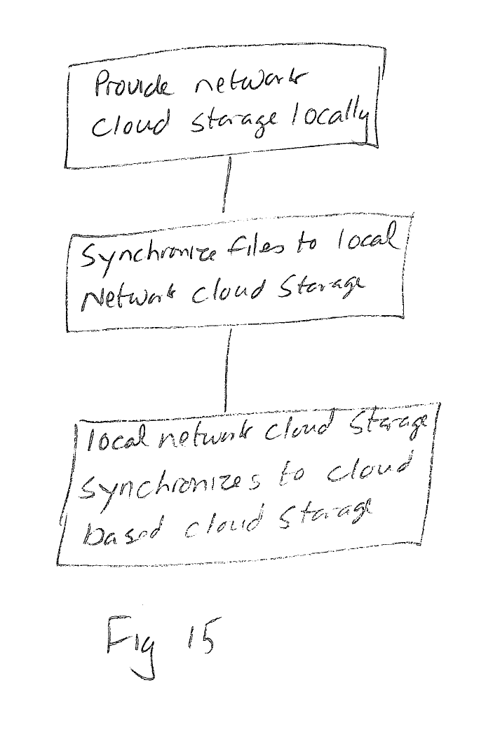

Referring to FIG. 15, shown is a simplified flow diagram of a method of supporting cloud storage in accordance with the first local cloud server architecture. A storage application is installed on the first local cloud server. The storage application synchronizes with local users synchronization folders. For example, each user has a “Local Cloud” folder that synchronizes with a storage location on the first local cloud server. Thus, every file within the “Local Cloud” folder on a user system is duplicated onto the first local cloud server non-volatile storage medium. When bandwidth is available, the data stored within the first local cloud server non-volatile storage medium and relating to the cloud storage application is duplicated to a global cloud storage medium. Though the term medium implies a physical medium, it is well understood that cloud storage media are virtual in nature and though each medium is physical and stores data in a non-volatile fashion, there is no specific single physical medium to which the data is transmitted, instead being stored somewhere accessible to the global cloud storage service.

When a user travels, they can retrieve information from their cloud storage as needed. That said, synchronizing to the cloud storage happens in two steps thereby improving reliability and response-time in the first step and convenience—the user need not maintain their computer powered and connected to the Internet—for the second. The first local cloud server non-volatile storage medium therefore improves both reliability and convenience of the overall system as well as allowing for load balancing and improved overall bandwidth utilization.

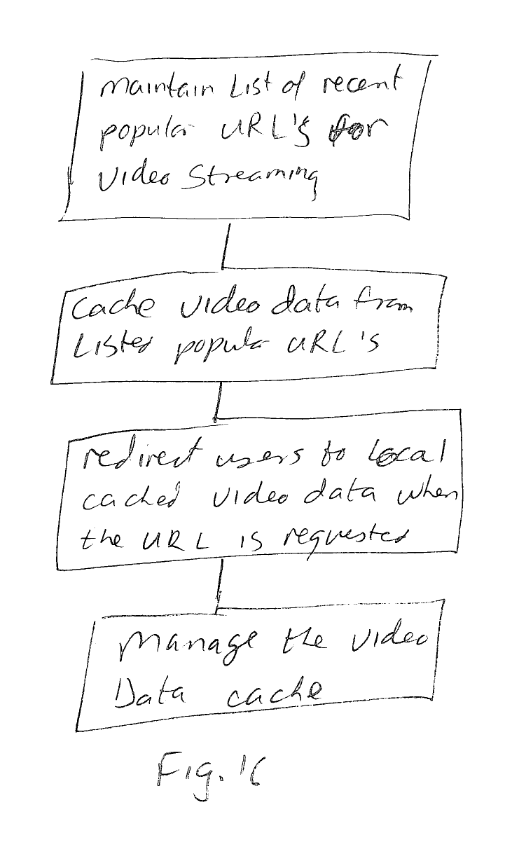

Referring to FIG. 16, shown is a simplified flow diagram of a method of supporting video streaming of popular clips relying on a first local cloud server. As a video clip is streamed, it and its URL are stored in a table in the first local cloud server non-volatile storage medium. When another user requests the same URL as is often the case for very popular content, the first local cloud server intercepts the request and provides the streaming video data from its non-volatile storage medium. Therefore less Internet bandwidth is used. Fortunately, a rolling list of popular URLs allows for connection with popular destinations exists absent Internet connectivity. Such a method as that shown in FIG. 16 is extremely useful with local applications for Facebook® and news, for example as it allows popular Facebook® links to function well when the global network remains inaccessible and allows for storage of video clips one time within the first local cloud server instead of numerous times. Further, a network storage medium is employable to increase the table size within a local network. Of course, a Facebook® local application optionally stores this video data separately for its subscribers and manages the links itself to ensure reliability.

In some embodiments, local applications are automatically updated on the first local cloud server while in other embodiments, the local applications require administrative intervention to be updated. When updating is automated, the updating application is a local application and optionally supports download operations responsive to network connectivity.

Though the embodiments are described with reference to a local server, it is envisioned that similar server features are implementable within an operating system of a personal computer or within a browser of a computer system. When the operating system or browser supports functionality as disclosed herein, each computer need not perform all the functions in isolation. Though computers today typically have sufficient resources to support a fully functional edge cloud server for a user of said computer system, enhanced efficiency and functionality is achieved by having the operating systems and/or internet browsers co-operate within the local area network to result in a distributed cloud service implemented locally and supporting all locally connected computer systems. In such an application, the local cloud server hardware requirements are obviated or, alternatively, greatly reduced. For example, a local cloud server has little storage and relies on local area network systems to store data for local retrieval. Similarly, the local cloud server may have limited processing resources and rely on local area network connected CPUs to perform complex functions when required.

Implementing the local cloud server within a Web Browser allows for a simple method to support cloud services hosted locally without requiring complex hardware, network, or management changes to the overall network. Further, it is implementable without altering or affecting security, firewalls, etc. for the local area network. Alternatively, the local cloud server is implemented within a browser plug-in that operates with browser software to provide a local cloud server or some local cloud server functionality.

Further alternatively, a local cloud server is implementable within a virtual machine or as a background task. In either case, the local cloud server is capable of operation without substantial effect on most computer users who tend to use little processing power and only a fraction of local network bandwidth. As such, implementing the local cloud server in software on user systems or network-installed systems is often a more cost effective solution that involves less ongoing management than installing a separate local cloud server, depending on usage scenarios.

Numerous other embodiments may be envisaged without departing from the spirit or scope of the invention.

1. A method comprising:
providing a first server communicatively coupled to the Internet and in communication with the Internet and communicatively coupled to a local network other than via the internet;
providing a first workstation in communication with the first server via the local network and other than via the Internet;
transmitting via the local network and other than via the Internet from the first workstation to the first server a request for access to a cloud service;
when communication via the Internet is available, accessing by the first server via the Internet the cloud service; and
when communication via the Internet to the cloud service is other than available, providing the cloud service by the first server via the local network.

2. A method according to claim 1 wherein the cloud service provided by the first server is similar to the cloud service provided by the cloud service.

3. A method according to claim 1 wherein the cloud service provided by the first server is identical to the cloud service provided by the cloud service on a known day and time.

4. A method according to claim 1 wherein the cloud service provided by the first server is a limited version of the cloud service provided by the cloud service.

5. A method according to claim 1 wherein the communication via the Internet is other than available when a quality of Internet connectivity is below a first threshold.

6. A method according to claim 5 wherein the first threshold is provided by a provider of the cloud service.

7. A method according to claim 5 wherein the first threshold is based on a parameter that is modifiable by an administrator of the server.

8. A method according to claim 5 wherein the first threshold is dynamically determined based on a network utilization and a quality of locally stored data from the cloud service.

9. A method according to claim 5 wherein the first threshold is dynamically determined based on a priority of a user from whom the request originates.

10. A method according to claim 1 wherein responses provided from a local server are provided to the workstation as if originating from the cloud service.

11. A method according to claim 1 wherein responses provided from a local server are provided to the workstation with an indication that they are being serviced by a local server.

12. A method comprising:
requesting of system addressed by a URL a response from the URL address, the URL for being resolved by a DNS and for being accessed via the internet;
determining within a network accessible other than via the Internet whether to access the URL via the Internet or to access a local cloud server for providing responses to queries directed to the URL, the local cloud server servicing requests of at least one URL and other than at the accurate DNS address for said at least one URL; and
when it is determined to service the request locally, serving data in response to the request and responsive thereto from the local cloud server,
wherein at least some requests are serviced locally and at least some requests are serviced from the accurate address as resolved by a DNS server for the URL.

13. A method according to claim 12 wherein determining within a network accessible other than via the Internet whether to access the URL via the Internet or to access a local cloud server is performed in dependence upon network availability when determining is performed.

14. A method according to claim 12 wherein determining within a network accessible other than via the Internet whether to access the URL via the Internet or to access a local cloud server is performed in dependence upon network reliability when determining is performed.

15. A method according to claim 12 wherein determining within a network accessible other than via the Internet whether to access the URL via the Internet or to access a local cloud server is performed in dependence upon quality of network communication when determining is performed.

16. A computer system comprising:
a processor, memory and a communication transducer, the computer system
for assessing network performance of an external network communicatively coupled with the communication transducer; and
for when the network performance is below a predetermined threshold, redirecting a first network request directed to an address within the external network to a server within a local network for being responded to, the server for providing similar functionality to a second server at the address within the external network.

17. A computer system according to claim 16 wherein redirecting is to the computer system.

18. A computer system according to claim 16 wherein redirecting is to another server within the local network.

19. A computer system comprising:
a processor, memory and a communication transducer, the computer system
for assessing network performance of an external network communicatively coupled with the communication transducer; and
for allowing some network traffic to be routed via the external network to access at least one of data and services from a server within the external network and for re-routing a first network request destined for a network location outside the local network and within the external network to a first server within the local network local to the computer system, the first server for responding to the first network request and for, in response thereto, providing a response to the first network request.
